(19) United States
(12) Patent Application Publication
(10) Pub. No.: US 2024/0133163 A1
(43) Pub. Date: Apr. 25, 2024

(54) WATER DISPENSING ASSEMBLY FOR CONNECTING TO A FIRE HYDRANT

(71) Applicant: The City of Medicine Hat, Medicine Hat (CA)

(72) Inventors: John Reeder, Medicine Hat (CA); Dayna Livingston, Medicine Hat (CA); Travis Schneider, Medicine Hat (CA); Tyler Noyes, Medicine Hat (CA); Daren Marshall, Medicine Hat (CA); Shawn C. Robins, Medicine Hat (CA); Todd Toews, Medicine Hat (CA); Troy Hannant, Medicine Hat (CA); Craig Banasch, Medicine Hat (CA); Allen J. Pribyl, Medicine Hat (CA); Graeme Dennis, Cyprus County (CA); Stuart Bonneville, Medicine Hat (CA); Pat Bohan, Medicine Hat (CA)

(21) Appl. No.: 18/048,612

(22) Filed: Oct. 20, 2022

(51) Int. Cl. E03B 9/20; B67D 1/00; E03B 9/04

(52) U.S. Cl. CPC E03B 9/20; B67D 1/0014; E03B 9/04; B67D 2001/0095

(57) ABSTRACT

A water dispensing assembly is provided that is adapted to connect to a fire hydrant water outlet, the fire hydrant being connected to a water supply, for safely dispensing clean water for filling water bottles and the like. The water dispensing assembly is a self-contained unit that is relatively compact and low maintenance. The water dispensing assembly can be housed in an enclosed box-like housing structure that is tamper proof so that it cannot be accessed or modified by the public at large.

### TECHNICAL FIELD

The following relates generally to a water dispensing assembly. More particularly, a water dispensing assembly is provided that is adapted to be fluidly connected to a fire hydrant so as to provide fresh water to the public for filling water bottles and the like.

### BACKGROUND

It is important, especially during the summer months, for a person to drink plenty of water to stay hydrated. However, often this is difficult to do when a person is away from home. While bottled water is available at most convenience stores, purchasing disposable water bottles can become expensive and is not environmentally friendly. Thus, the current trend has been for individuals to carry reusable water bottles filled with fresh water to keep a supply of water when away from home. However, it is often difficult to find a facility, such as a water bottle filling station, to refill these reusable water bottles. Further, many water dispensing units used in commercial establishments are coin operated.

Thus, there is a need for water bottle filling stations that are readily available at no cost to the general public that safely dispense fresh, reliable water for filling water bottles and the like.

### SUMMARY

The current application is directed to a water dispensing assembly that can be connected to an outlet that is present on an accessible, above-ground portion of a fire hydrant. Typically, fire hydrants, particularly in North America, have multiple water outlets for attaching a fire hose thereto. These water outlets are often referred to as “hose nozzles” and the water dispensing assembly will be connected to one of these outlets, which then will allow individuals to safely fill their water bottles and the like with fresh water. Thus, water dispensing assemblies of the present application can be scattered throughout a town or city to provide the public with clean water for filling water bottles and the like when away from home.

The water dispensing assembly presented herein uses a municipality's water supply via municipal fire hydrants while ensuring that this water supply remains uncontaminated. The water dispensing assembly is a self-contained unit that is relatively compact and low maintenance. The water dispensing assembly can be housed in a housing structure that is tamper proof (e.g., one having a door that can be locked) so that it cannot be accessed or modified by the public at large.

When the water dispensing assembly presented herein is connected to a fire hydrant having multiple outlets, typically three or more, the assembly does not interfere with the functionality of the fire hydrant for fire control. This will be described in more detail below.

Broadly stated, in one aspect, a water dispensing assembly is provided that is adapted to connect to a fire hydrant water outlet, the fire hydrant being connected to a water supply, the water dispensing assembly comprising:
a valve fluidly connected to the fire hydrant water outlet, the valve being operable to move between an open position to allow water to flow from the fire hydrant to the water dispensing assembly and a closed position to stop the flow of water from the fire hydrant;
a fluid hose having an input end and an output end, the input end of the fluid hose being fluidly connected to the valve and the output end of the fluid hose having a dispensing orifice for dispensing the water;
a backflow preventer fluidly connected to the fluid hose to prevent backflow contamination of the water supply; and
optionally, a water pressure regulator fluidly connected to the fluid hose for reducing the pressure of the incoming water from the fire hydrant so that the water dispensed from the dispensing orifice is being dispensed at a reduced pressure.

In one embodiment, the water dispensing assembly further comprises a spigot attached to the dispensing orifice. In one embodiment, the spigot comprises a self-closing valve.

In one embodiment, the water dispensing assembly comprises the water pressure regulator. In this embodiment, the fluid hose comprises a first hose portion having the input end and a second hose portion having the output end, whereby the backflow preventer is fluidly connected to the first hose portion and the water pressure reducing valve is fluidly connected to the second hose portion, the backflow preventer and the water pressure regulator being fluidly connected to one another.

In one embodiment, the water dispensing assembly further comprises a water meter for determining the amount of water that is being dispensed in a given time period.

In one embodiment, the water dispensing assembly further comprises a flushing unit fluidly connected thereto for discharging water from the water dispensing assembly from time to time.

In one embodiment, the water dispensing apparatus is contained in an enclosed housing structure, said housing structure having a door to access components of the water dispensing assembly.

Additional aspects and advantages of the water dispensing assembly will be apparent in view of the description, which follows. It should be understood, however, that the detailed description and the specific examples, while indicating preferred embodiments of the water dispensing assembly, are given by way of illustration only, since various changes and modifications will become apparent to those skilled in the art from this detailed description.

### BRIEF DESCRIPTION OF THE DRAWINGS

Referring to the drawings wherein like reference numerals indicate similar parts throughout the several views, several aspects of the water dispensing assembly are illustrated by way of example, and not by way of limitation, in detail in the following figures. It is understood that the drawings provided herein are for illustration purposes only and are not necessarily drawn to scale

FIG. 1 is a schematic, perspective view from the front of one embodiment of a water dispensing assembly where the front door of the housing has been removed.

FIG. 2 is an exploded schematic of the internal components of the water dispensing assembly of FIG. 1, which illustrates how all of the components of the water dispensing assembly are fluidly connected.

FIGS. 3A and 3B are perspective views of the housing used to house the water dispensing assembly with the door open and door closed, respectively.

### DETAILED DESCRIPTION

The detailed description set forth below in connection with the appended drawings is intended as a description of various embodiments of the water dispensing assembly and is not intended to represent the only embodiments contemplated. The detailed description includes specific details for the purpose of providing a comprehensive understanding of the water dispensing assembly of the present application. However, it will be apparent to those skilled in the art that the water dispensing assembly of the present application may be practiced without these specific details.

The following relates generally to a water dispensing assembly that fluidly connects to a fire hydrant to allow individuals to safely fill their water bottles and the like with fresh water.

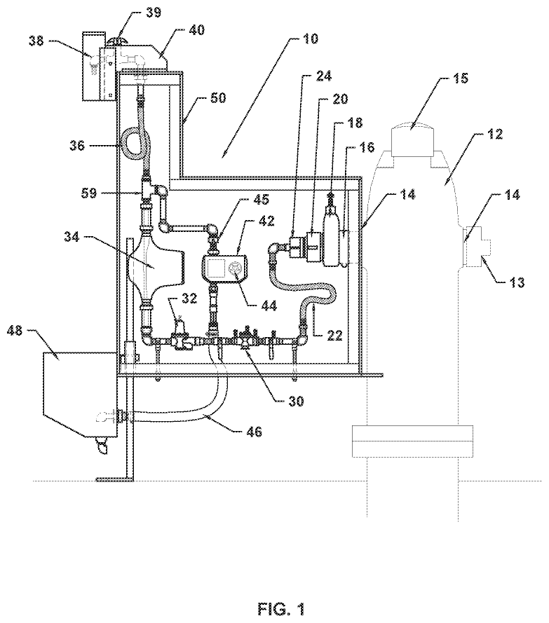

FIG. 1 is a schematic, perspective view from the front of one embodiment of a water dispensing assembly where the front door of housing 50 has been removed. As shown in FIG. 1, water dispensing assembly 10 is adapted to be fluidly connected to a fire hydrant 12, in particular, to the threads (not shown) of a fire hydrant water outlet 14, by means of a swivel connector 16. The fire hydrant is fluidly connected to a water supply such as a municipal water supply. To operate the water dispensing assembly 10, the fire hydrant 12 is “charged”, i.e., is under pressure so that water from the water supply can freely flow from the fire hydrant 12 to the water dispensing assembly 10. However, when initially connecting the water dispensing assembly to the fire hydrant, the fire hydrant is not “charged”, i.e., it is turned off. Connection of the water dispensing assembly 10 to fire hydrant 12 will be discussed in more detail below.

As can be seen in FIG. 1, fire hydrant 12 is shown having two water outlets 14. However, it is understood that fire hydrants could have more than two water outlets. Generally, water outlets comprise an outlet cap 13 (also referred to as “pumper caps”), which outer cap, as can be seen in FIG. 1, has been removed from the left hand water outlet 14 so that the water dispensing assembly 10 can be attached thereto via swivel connector 16. Fire hydrant 12 further comprises a locking cap 15 (also referred to as a “dome cap”), which is used to protect operating nut (not shown), which operating nut, when turned in one direction opens a valve of the fire hydrant to allow the water to flow through outlets 14 and when turned in the opposite direction, closes the fire hydrant valve to stop the flow of water. A hydrant wrench having a key specific for the locking cap 15 is used to remove locking cap 15. The hydrant wrench may further comprise an opening or box end that is designed to grip the operating nut to turn on the hydrant, i.e., open the fire hydrant valve to allow the flow of water. When the operating nut is in the open position, the fire hydrant is considered to be “charged”. Generally, once the fire hydrant is “charged”, locking cap 15 is replaced on the fire hydrant.

Turning again to the water dispensing assembly 10 of FIG. 1, fluidly connected to the first swivel connector 16 is a gate valve 18, which valve can be opened or closed by means of an actuator such as a handle, hand wheel or a motor. It is understood, however, that valves other than gate valves that are well known in the art could also be used. When the gate valve 18 is in the fully opened position, water can freely flow from the fire hydrant 12 to the water dispensing assembly 10. In this embodiment, the gate valve has an inner diameter of 2½ inches when in the fully open position to accommodate the inner diameter of the fire hydrant outlet. It is understood, however, that other types of connectors can be used to connect the fire hydrant outlet to the water dispensing assembly 10, however, the use of a swivel connector will prevent kinking and compression of the first fluid hose 22.

The gate valve 18 is further fluidly connected at its opposite end to an adapter 20, which adapter, in this embodiment, is a 2½ inch to 2 inch adapter. Fluidly connected to adapter 20 is a reducer 24, which, in this embodiment, is a 2 inch to ½ inch reducer. Thus, all of the subsequent (downstream) piping, elbows, tubing, etc. of the water dispensing assembly will generally have an internal diameter of ½ inch. Because the water dispensing assembly will be primarily used for filling water bottles and the like, there is no need to have the downstream piping to have a large diameter. Further, by reducing the size of the downstream piping, the water dispensing assembly is more compact and can readily fit into housing 50, thereby leaving a much smaller footprint. Housing 50 will be described in more detail below.

Water dispensing assembly 10 further comprises first fluid tube 22, which is in fluid communication with reducer 24. First fluid tube 22 is preferably a flexible tubing such as flexible braided stainless steel tubing. Preferably, first fluid tube 22 is made from stainless steel to reduce oxidation, scale build up and avoid contamination, however, it is understood that other corrosion-resistant materials could be used such as copper, aluminum, brass, polyethylene (PE) and the like. Fluidly connected to the opposition end of first fluid tube 22 is a reduced pressure backflow assembly 30 (also commonly referred to as a reduced pressure backflow preventer), which is designed to prevent backflow of water caused either by back-pressure or back-siphonage. In general, a backflow preventer only allows water to flow in one direction but never in the opposite direction. A reduced pressure backflow assembly incorporates the use of two independently acting spring-loaded check valves separated by a spring-loaded differential pressure relief valve, two resilient seated shutoff valves and four properly located test cocks. Thus, they work like a double-check (DC) backflow preventer, but also have an intermediate relief valve that opens to the atmosphere if both check valves should fail. Backflow preventers work by letting water flow through them in one direction, but prevent water from flowing back through them in a reverse direction. This is important in order to prevent risk to the water supply quality from any backflow contamination. It is understood, however, that a double or dual backflow preventer may be used in place of a reduced pressure backflow assembly, depending on the level of risk and what current safety codes are where the assembly is being installed.

Water dispensing assembly 10 as shown in FIG. 1 further comprises water pressure reducing valve 32, which pressure reducing valve 32 is fluidly connected to reduced pressure backflow assembly 30 to reduce the high pressure of the incoming water from the fire hydrant 12, thereby providing a lower, more functional pressure for dispensing the water to the end user. Water pressure reducing valves (also referred to as a pressure regulators) are well-known in the art and are generally self-acting automatic control valves for reducing a higher inlet pressure to a constant, reduced outlet pressure so that water is dispensed at a safe pressure level. However, it is understood that the need for a pressure regulator will depend upon the pressure of the main water lines of a particular municipality. Hence, if a municipality uses lower pressure or a different type of delivery spigot, it is possible that a pressure reduce may not be necessary.

Fluidly connected to the water pressure reducing valve 32 is water meter 34, which is used to monitor the amount of water that is being used. Useful water meters are well-known in the art and may be positive displacement, turbine, or magnetic water meters. A second fluid hose 36 is fluidly connected at one end to the water meter 34, said second fluid hose having a dispensing orifice with a spigot (spout, faucet) 38 fluidly connected thereto for dispensing water. In one embodiment, a spring-loaded spigot having a self-closing valve 39 is used so that the water flow will automatically stop once pressure is relieved from the self-closing valve 39. However, it is understood that any spigot, spout, faucet could be used in the present invention. Ideally, the spigot should be designed to prevent contamination by the end-user. As shown in FIG. 1, in this embodiment, the spigot 38 is covered by a cover or guard 40 to further reduce the risk of contamination.

Water dispensing assembly 10 can also be equipped with a flushing unit (or discharge unit) 42, which, as shown in FIG. 1, is fluidly attached to one end of second fluid hose 36 by means of tee pipe 59. The water flushing unit 42 may be a timer controlled valve, as shown in FIG. 1, which generally comprises a valve (not shown) and a timer 44, which can be an electronic timer that is battery operated. The timer 44 can be set to open the valve (not shown) at a given time schedule, e.g., every six hours, to flow water through the system/hydrant to keep it cool and fresh. Flushed water is then discharged for a period of five minutes or so. As mentioned, occasional flushing of the assembly keeps the water cool and free from potential particulates such as rust particulates, which may affect the quality of the water and affect the working of various components of the assembly such as valves and the like. In addition, on occasion, depending upon where the assembly is installed, sand/grit can make its way into the system if the system undergoes a water line break repair and does not flush the line completely to remove said debris. Flushed water is discharged through flushing tubing 46, which is fluidly connected to the water flushing unit 42, and the water can be collected in a drain trough 48 having an outlet at its bottom for discharging the water onto the ground. Water flushing unit 42 may further comprise a shut off hose bib valve 45 for isolating the timer 44 (i.e., shutting off the flow of water thereto) when the timer batteries need to be changed.

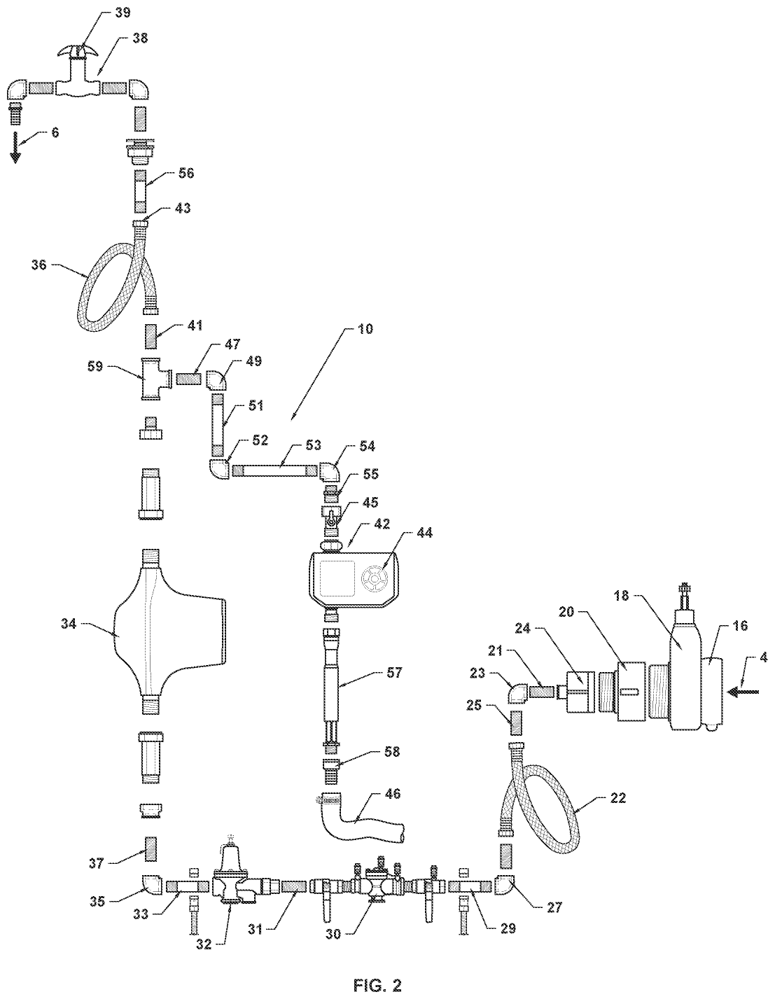

It is understood that various piping or pipefittings such as nipples, elbows, and like are used to place the various components described above in fluid communication with one another, all of which are well known in the art. The details of such piping or pipefittings for fluidly connecting the components of the water dispensing assembly together are shown in FIG. 2.

FIG. 2 is an exploded schematic of the components of the water dispensing assembly of FIG. 1 and illustrates how all of the components of the water dispensing assembly are fluidly connected to each other by using piping or pipefittings know in the art. Starting from right to left, FIG. 2 shows the flow of water 4 entering the assembly via swivel connector 16, which is then fluidly connected to gate valve 18. Gate valve 18 is a 2½ inch hydrant gate valve, which is then fluidly connected to 2 inch adapter 20 and 2 inch to ½ inch reducer 24. Reducer 24 is fluidly connected to first fluid tube 22 via close nipple 21, 90 degree elbow 23 and close nipple 25, respectively. Use of a 90 degree elbow allows for the assembly to be more compact and have a reduced foot print.

First fluid hose 22 is connected at its opposite end to reduced pressure assembly backflow preventer 30 at its one end via close nipple 27, 90 degree elbow and close nipple 29, respectively. At its opposite end, backflow preventer 30 is fluidly connected to one end of water pressure reducing valve 32 via close nipple 31. While having a water meter 34 is optional, in this embodiment, water meter is fluidly connected to the opposite end of water pressure reducing valve 32 via close nipple 33, 90 degree elbow 35 and close nipple 37, respectively. Tee pipe 59 is used to fluidly connect water meter 34 to second fluid hose 36, as well as water flushing unit 42.

Water flushing unit 42 comprising timer 44 is connected to tee pipe 59 via nipple 47, 90 degree elbow 49, nipple 51, 90 degree elbow 52, nipple 53 and 90 degree elbow 54, respectively. As previously mentioned, water flushing unit 42 may also comprise shutoff hose bib valve 45, which can be fluidly connected to 90 degree elbow 54 by means of male to hose bib male 54. Flushing tubing 46 is fluidly connected to water flushing unit 42 by means of air gap fitting 57 and fitting 58. It is understood that air gap fitting 57 and fitting 58 can be manufactured as a single fitting. Air gap fittings are well known in the art and are manufactured by a number of plumbing manufacturing companies. Air gap fitting 57 prevents cross-connections and contamination by discharging the flushed water across an unobstructed space (i.e., a gap of air). Thus, the flushed water flows across empty air into flushing tube 46 and, ultimately, into drain trough 48; however, in the event of back-up, the back-up water cannot reach the potable water supply due to the presence of this gap or space.

Spigot 38 is connected to the other end of second fluid hose 36 by means of nipple 56. Useful spigots are well known in the art. Spigot 38 as shown in FIG. 2 is operated by means of self-closing valve 39. Thus, water 6 flows from spigot 38 into a receptacle such as a water bottle and the like of the end user.

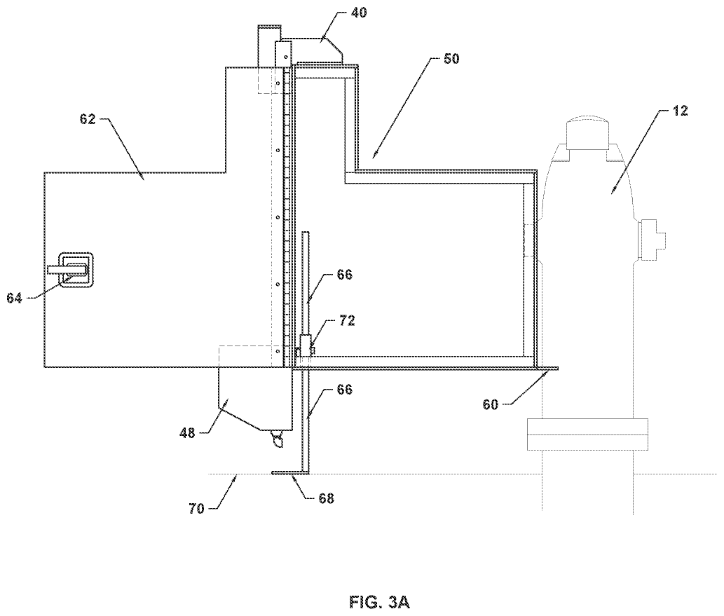

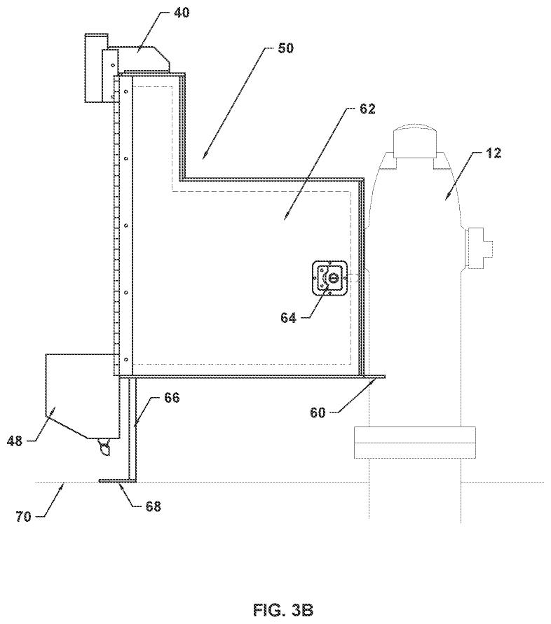

FIGS. 3A and 3B illustrate the housing 50 for housing the water dispensing assembly 10 to prevent tampering and ensure the safety of the end user. FIG. 3A shows the housing 50 with the door open and FIG. 3B shows the housing with the door closed. Housing 50 is generally an enclosed box-like structure which encloses the entirety of the water dispensing assembly of the present invention and which can be made from any number of materials but it is preferably made from sheet metal, for example, aluminum sheet metal. Metals used in the sheet metal industry include cold rolled steel, mild steel, stainless steel, tin, nickel, titanium, aluminum, brass, and copper. Metal sheets are welded together to provide a rigid support structure. The overall height of the housing is approximately 28.5 inches, its depth approximately 10 inches and its width approximately 22.75 inches, showing that the water dispensing assembly of the present invention has a relatively compact configuration and does not take up a large amount of space.

With reference now to FIGS. 3A and 3B, housing 50 can be coupled to and supported by fire hydrant 12 by means of support bracket 60. Housing 50 further comprises door 62, which, when opened, exposes to view the various components of the water dispensing assembly and which comprises a hinge such as a stainless steel hinge for attaching to the housing 50. Door 62 is equipped with a locking mechanism 64, which is preferably tamper-resistant, such as a paddle lock. Different types of door locks and handles could be used, including knob locks, padlocks, levels, deadbolts and paddle locks. Further, as discussed above, housing 50 may comprise drain trough 48 for collecting and draining flushed water, and spigot cover 40. Housing 50 can be further supported by at least one support leg 66 having a support brace 72, which support leg 66 can have a metal plate 68 at its lowest end for bolting the housing 50 to, for example, a cement sidewalk 70 and the like.

The steps for attaching a water dispensing assembly of the present application to a standard fire hydrant will now be described in more detail with reference to water dispensing assembly 10 as shown in FIG. 1. Initially, gate valve 18 of water dispensing assembly 10 is in the closed position and the fire hydrant is “uncharged”. The water dispensing assembly 10 is then fluidly attached a fire hydrant water outlet via swivel connector 16. Locking cap 15 (or dome cap) is then removed and the operating nut is placed in the open position, which will allow water into the fire hydrant barrel, i.e., the hydrant is now “charged”. Any air in the hydrant and the water dispensing assembly 10 is displaced by opening both spigot 38 and flushing tubing 46, which is fluidly connected to water flushing unit 42 of the water dispensing assembly, by cracking gate valve 18 slightly, thereby allowing water to enter the assembly and displace the air. When the air has been displaced from both the hydrant and the water dispensing assembly, the spigot 38 and flushing tube 46 are both closed. Both the hydrant and the water dispensing assembly 10 is then allowed to pressurize, while checking for leaks, and then the gate valve 18 of the assembly is then fully opened and the locking cap 15 is installed again. Before the water dispensing assembly can be put into service, it must pass two (2) consecutive bacteriological tests. From time to time, the water dispensed from the assembly is also checked for turbidity using a turbidimeter and ideally should be <1.00 NTU. Further, from time to time, a chlorometer is used to ensure the chlorine residual is between about 0.10 mg/L and 1.00 mg/L.

In the event of a situation where a fire hydrant having a plurality of water outlets and having a water dispensing unit attached to one of the water outlets is required to be put into service for controlling a fire, the following steps can be followed to now allow the fire hydrant to be operational for fire control despite the water dispensing assembly being attached thereto. Initially, a hydrant wrench, which can be a multi-purpose hydrant wrench that has one end for removing the locking cap, the other end for placing the operating nut in the open or closed position, and a hook to loosen and tighten other hydrant fittings such as gate valves or fire hoses, etc., is used to remove the locking cap 15 to expose the operating nut, which operating nut is in the open position to allow the water to flow to the water dispensing assembly. It is understood, however, that individual wrenches for each hydrant fitting can be used. The hydrant wrench is then used to close the operating nut, i.e., turn the fire hydrant off, to relieve the pressure so that an outlet cap or pumper cap can be removed from one of the free water outlets using the multi-purpose hydrant wrench. A hose is then attached to the free water outlet by using the multi-purpose hydrant wrench. The operating nut is then opened again using the multi-purpose hydrant wrench to “charge” the hydrant again. The hydrant is then ready to deliver water to the firefighting equipment, e.g., hose, as needed. Once the hydrant is no longer needed for the firefighting operation, the hydrant operating nut is turned off, the hose(s) removed and both the outlet (pumper) cap and the locking (dome) cap are reinstalled their respective places. Generally, the hydrant is left turned off (out of service) so that the hydrant can be inspected for any maintenance requirements prior to the water dispensing assembly being put back into service.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, 10%, 20%, or +25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

The scope of the claims should not be limited by the preferred embodiments set forth in the examples, but should be given the broadest interpretation consistent with the description as a whole.

1. A water dispensing assembly adapted to connect to a fire hydrant water outlet, the fire hydrant being connected to a water supply, the water dispensing assembly comprising:
a valve fluidly connected to the fire hydrant water outlet, the valve being operable to move between an open position to allow water to flow from the fire hydrant to the water dispensing assembly and a closed position to stop the flow of water from the fire hydrant;
a fluid hose having an input end and an output end, the input end of the fluid hose being fluidly connected to the valve and the output end of the fluid hose having a dispensing orifice for dispensing the water from the water supply;
a backflow preventer fluidly connected to the fluid hose to prevent backflow contamination of the water supply; and
optionally, a water pressure regulator fluidly connected to the fluid hose for reducing the pressure of the incoming water from the fire hydrant so that the water dispensed from the dispensing orifice is being dispensed at a reduced pressure.

2. The water dispensing assembly as claimed in claim 1 further comprising a spigot fluidly connected to the dispensing office for dispensing the water from the water supply.

3. The water dispensing assembly as claimed in claim 2, wherein the spigot comprises a self-closing valve.

4. The water dispensing assembly as claimed in claim 1 comprising the water pressure regulator, wherein the fluid hose comprises a first hose portion having the input end and a second hose portion having the output end, whereby the backflow preventer is fluidly connected to the first hose portion and the water pressure reducing valve is fluidly connected to the second hose portion, the backflow preventer and the water pressure regulator being fluidly connected to one another.

5. The water dispensing assembly as claimed in claim 1 further comprising a water meter for determining the amount of water that is being dispensed in a given time period.

6. The water dispensing assembly as claimed in claim 1 further comprising a flushing unit fluidly connected thereto for discharging water from the water dispensing assembly from time to time.

7. The water dispensing assembly as claimed in claim 1 further comprising at least one adapter/reducer fluidly attached to the valve in order to reduce an inner diameter of the fluid hose.

8. The water dispensing assembly as claimed in claim 1, wherein the fluid hose is made from flexible braided stainless steel tubing.

9. The water dispensing assembly as claimed in claim 6, wherein the flushing unit comprises a battery-operated timer.

10. The water dispensing assembly as claimed in claim 1 further comprising an enclosed housing structure having a door for housing the water dispensing assembly therein.

11. The water dispensing assembly as claimed in claim 10, wherein the door of the housing structure further comprises a locking mechanism.

12. The water dispensing assembly as claimed in claim 10, wherein the housing structure is coupled to and supported by fire hydrant by means of a support bracket.

13. The water dispensing assembly as claimed in claim 6, further comprising a flushing tube, whereby the flushing tube is fluidly connected to the flushing unit by means of an air gap fitting to prevent cross-connections and contamination.

14. The water dispensing assembly as claimed in claim 1, whereby the valve is fluidly connected to the hydrant outlet by means of a swivel connector.

15. A water dispensing assembly adapted to connect to a fire hydrant water outlet, the fire hydrant being connected to a water supply, the water dispensing assembly comprising:
a connector fluidly connected to the fire hydrant water outlet;
a valve fluidly connected to the swivel connector, the valve being operable to move between an open position to allow water to flow from the fire hydrant to the water dispensing assembly and a closed position to stop the flow of water from the fire hydrant;
at least one adapter/reducer fluidly attached to the valve;
a first fluid hose having an input end and an output end, the input end of the fluid hose being fluidly connected to the at least one adapter/reducer and the output end of the first fluid hose being fluidly connected to a backflow preventer to prevent backflow contamination of the water supply;
a water pressure regulator fluidly connected to the first fluid hose for reducing the pressure of the incoming water from the fire hydrant so that the water dispensed from the water dispensing apparatus is being dispensed at a reduced pressure;
a water meter fluidly connected to the opposite end of water pressure regulator for monitoring the amount of water that is being used;
a water flushing unit having a timer fluidly attached to the water meter, said water flushing unit further comprising a flushing tube, for periodically flushing the water dispensing assembly;
a second fluid hose having an input end and an output end, the input end being fluidly attached to the water meter and the outlet end being fluidly attached to a spigot for dispensing the water from the water supply;
wherein the at least one adapter/reducer is used to reduce an inner diameter of the first and second fluid hose.

16. The water dispensing assembly as claimed in claim 15, whereby the flushing tube is fluidly connected to the flushing unit by means of an air gap fitting to prevent cross-connections and cross-contamination.

17. The water dispensing assembly as claimed in claim 15 further comprising an enclosed housing structure having a door for housing the water dispensing assembly therein.

18. The water dispensing assembly as claimed in claim 17, wherein the door of the housing structure further comprises a locking mechanism.

19. The water dispensing assembly as claimed in claim 17, wherein the housing structure is coupled to and supported by fire hydrant by means of a support bracket.
